(19) United States
(12) Patent Application Publication
(10) Pub. No.: US 2008/0190375 A1
(43) Pub. Date: Aug. 14, 2008

(54) Animal Grooming Apparatus

(76) Inventors: Michael K. German, Greer, SC (US); Danelle S. German, Greer, SC (US)

Correspondence Address: HARSHAW RESEARCH, INC., 210 W. TECUMSEH STREET, OTTAWA, KS, 66067, US

(21) Appl. No.: 11/673,907

(22) Filed: Feb. 12, 2007

(51) Int. Cl. A01K 13/00

(52) U.S. Cl. 119/606; 119/712

(57) ABSTRACT

An animal grooming apparatus includes an enclosure defining a holding area and having a floor, a ceiling, and a plurality of walls. The grooming apparatus includes a forced air dryer outside the holding area and a hose coupled to the forced air dryer and extending inside the holding area for guiding air from the forced air dryer to the holding area. A vacuum pump is positioned outside the holding area and includes an intake and an exhaust. A duct extends from the holding area to the vacuum pump intake. A removable waste bag may be coupled to the vacuum pump for containing items passed through the duct. A filter may be coupled to the vacuum pump between the waste bag and the pump exhaust. A tray may be positioned below the floor and the floor may be grated to allow fluid to pass through the holding area to the tray.

### BACKGROUND OF THE INVENTION

The present invention relates generally to animal grooming equipment and, more particularly, to an animal grooming apparatus for containing an animal during a grooming procedure and that protects the arms and hands of the groomer and that removes hair and debris that may be dislodged from the animal.

Bathing, drying, and grooming an animal leads to a very desirable result for a pet and for the pet owner. However, this process may a difficult task even for professional pet groomers in that the pet often becomes agitated, especially when being dried with a forced air device such as a blow dryer. An agitated pet may lead to injury of the groomer. Further, the use of heated air may lead to injury of the pet. Still another problem is that a significant amount of loose hair or other debris may be stirred up into the air during the drying procedure. Yet another problem is that the animal may urinate while standing in a drying enclosure which leads to an unsanitary or unpleasant environment.

Various devices have been proposed in the art for drying animals following a bathing event. Although assumably effective for their intended purposes, the existing devices do not adequately contain the animal in a way that avoids injury to the groomer, avoids injury to the animal, removes loose hair or debris that may be stirred up during the drying process, or results in an unsanitary environment.

Therefore, it would be desirable to have an animal grooming apparatus that overcomes the above described disadvantages.

### SUMMARY OF THE INVENTION

An animal grooming apparatus according to the present invention includes an enclosure defining a holding area and having a floor, a ceiling, and a plurality of walls. The grooming apparatus also includes a forced air dryer outside the holding area and a hose coupled to the forced air dryer and extending inside the holding area for guiding air from the forced air dryer to the holding area. A vacuum pump is positioned outside the holding area and includes an intake and an exhaust. A duct extends from the holding area to a point adjacent the vacuum pump intake. A removable waste bag may be selectively coupled to the vacuum pump for containing items that are passed through the duct such as hair or other debris. A filter may be coupled to the vacuum pump between the waste bag and the pump exhaust. A tray may be removably positioned below the floor and the floor may be grated to allow fluid, such as urine, to pass through the holding area to the tray.

A general object of this invention is to provide an animal grooming apparatus for enclosing an animal in a holding area while it is dried and groomed.

Another object of this invention is to provide an animal grooming apparatus, as aforesaid, having at least one door defining an opening through which a groomer may have access to the animal.

Still another object of this invention is to provide an animal grooming apparatus, as aforesaid, that includes forced air for drying the animal.

Yet another object of this invention is to provide an animal grooming apparatus, as aforesaid, that allows fluid such as urine to pass through the floor to a removable tray.

A further object of this invention is to provide an animal grooming apparatus, as aforesaid, having a vacuum pump for collecting hair or other debris into a removable waste bag.

A still further object of this invention is to provide an animal grooming apparatus, as aforesaid, having a filter for collecting debris prior to it reaching the waste bag.

A particular object of this invention is to provide an animal grooming apparatus, as aforesaid, in which the hose blowing forced air may be selectively positioned for directing air upon desired portions of the animal.

Other objects and advantages of the present invention will become apparent from the following description taken in connection with the accompanying drawings, wherein is set forth by way of illustration and example, embodiments of this invention.

### BRIEF DESCRIPTION OF THE DRAWINGS

FIG. 1 is a perspective view of an animal grooming apparatus according to a preferred embodiment of the present invention;

FIG. 2 is another perspective view of the animal grooming apparatus as in FIG. 1 with one access door in an open configuration;

FIG. 3 is another perspective view of the animal grooming apparatus as in FIG. 2 taken from another angle and with a tray partially removed from the enclosure;

FIG. 4a is a rear perspective view of the animal grooming apparatus with part of the enclosure walls removed; and

FIG. 4b is an isolated view on an enlarged of a portion of the animal grooming apparatus shown in FIG. 4a.

### DESCRIPTION OF THE PREFERRED EMBODIMENT

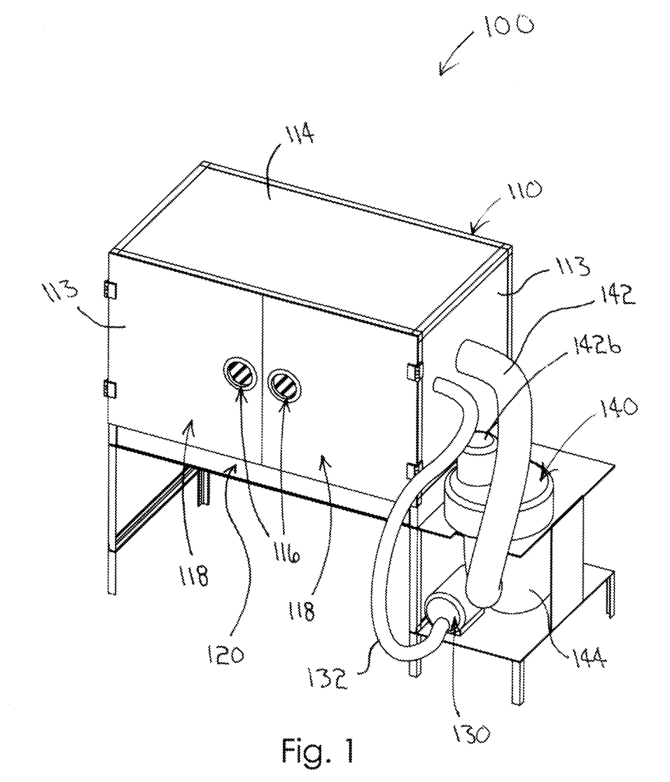

An animal grooming apparatus 100 according to the present invention will now be described in detail with reference to FIGS. 1 through 4b of the accompanying drawings. More particularly, an animal grooming apparatus 100 according to the current invention includes an enclosure 110, a forced air dryer 130, and a vacuum pump 140.

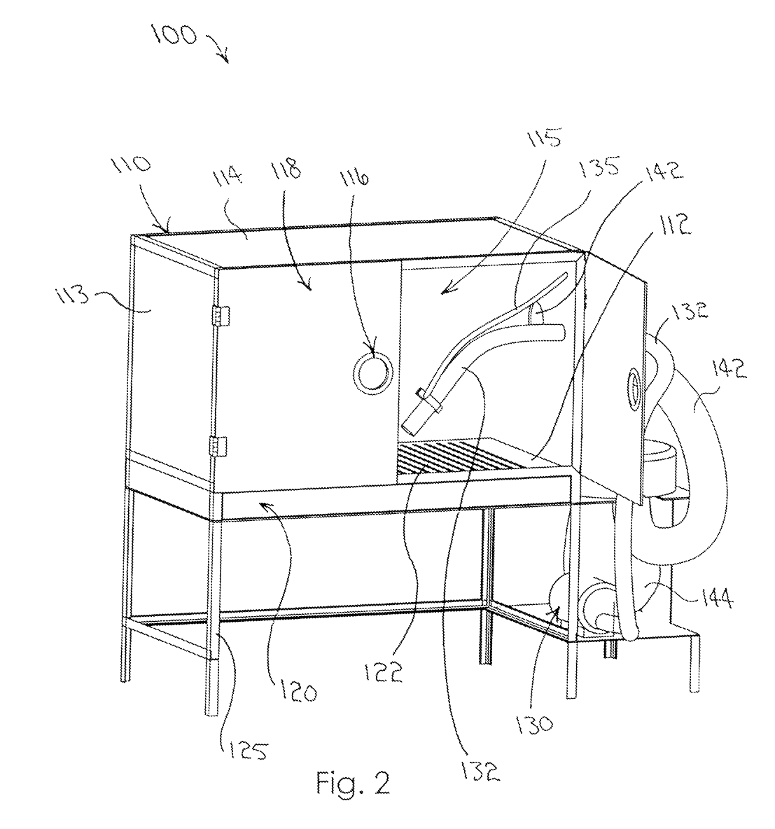

The enclosure 110 has a floor 112 (FIG. 2) and a plurality of walls 113 that collectively define a holding area 115 (FIG. 2). The enclosure 110 may further include a ceiling 114, as shown in FIG. 1. At least one of the walls 113 may define one or more access holes 116 sized to pass a human hand and forearm therethrough, and at least one of the walls 113 may include one or more door 118. As shown in FIG. 1, a single wall 113 may include two doors 118, and each door 118 may define a respective access hole 116. A portion or all of the walls 113 (including the doors 118) and/or the ceiling 114 may be transparent.

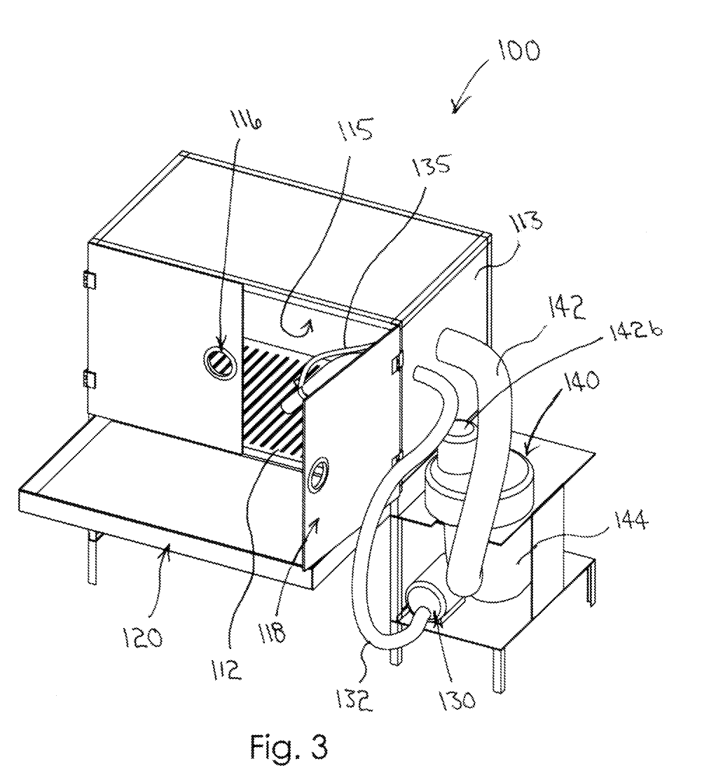

A tray 120 (FIGS. 2 and 3) may be removably positioned below the floor 112, and the floor 112 may be grated to allow fluid to pass from the holding area 115 to the tray 120. In other words, the floor 112 may include a plurality of small-diameter openings 122 (FIGS. 2 and 3) that allow fluid to pass through but that do not allow an animal to pass through. The tray 120 may be removed from the enclosure 110 (FIG. 3). A plurality of legs 125 may be coupled to the enclosure 110 to maintain the enclosure 110 at a preselected height (e.g., three feet, four feet, etc. from a ground surface).

The forced air dryer 130 is outside the holding area 115, and a hose 132 is coupled to the forced air dryer 130. The hose 132 extends inside the holding area 115 for guiding air (i.e., unheated air) from the forced air dryer 130 to the holding area 115. As shown in FIGS. 2 and 3, a flexible arm 135 may be inside the holding area 115. The flexible arm 135 may be coupled to the hose 132 for selectively maintaining the hose 132 in a plurality of respective configurations. In other words, the arm 135 may hold the hose 132 at different positions inside the holding area 115.

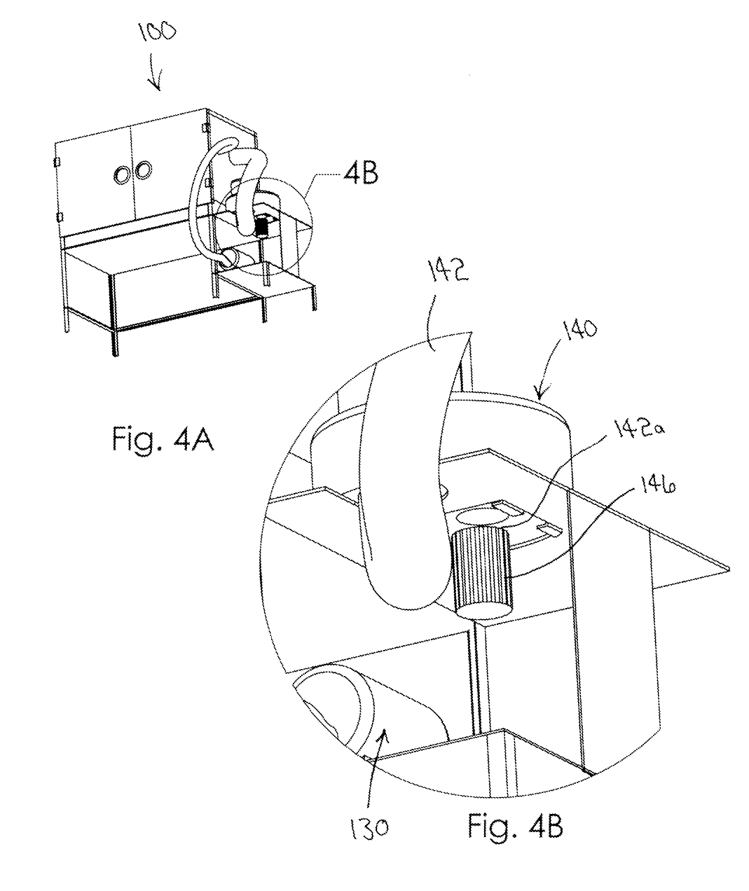

The vacuum pump 140 is outside the holding area 115 and has an intake 142a (FIG. 4b) and an exhaust 142b (FIG. 1). A duct 142 extends from the holding area 115 (FIG. 2) to adjacent the vacuum pump intake 142a (FIG. 4b). A removable waste bag 144 (FIGS. 1, 2, and 3) may be selectively coupled to the vacuum pump 140 for containing items passed through the duct 142. As shown in FIG. 4b, a removable filter 146 may be selectively coupled to the vacuum pump 140 between the waste bag 144 and the vacuum pump exhaust 142b to keep the items passed through the duct 142 in the waste bag 144.

In use, an animal (e.g., a cat or dog) may be placed in the holding area 115. For example, a respective door 118 may be opened (FIG. 2) to allow the animal to enter the holding area 115 and then closed (FIG. 1) once the animal is inside the holding area 115. The user may then use the air from the forced air dryer 130 to dry the animal by putting one or two hands through the access holes 116 and manipulating the hose 132 directing the air. To keep from burning the animal, it may be important that the air from the forced air dryer 130 is unheated. The flexible arm 135 may keep the hose 132 at different positions as discussed above. The transparency of the walls 113 and/or the ceiling 114 may allow the user to view the animal and the hose 132. As such, the user may position the flexible arm 135 and the hose 132 at a desired position and then use his hands to brush or otherwise groom the animal while the air blows on the animal.

The vacuum pump 140 may draw stray hair or debris from the holding area 115 through the duct 142. The filter 146 may ensure that the hair or debris that has passed through the duct 142 is collected in the waste bag 144, and the waste bag 144 and/or the filter 146 may be cleaned or replaced as appropriate. Urine or other liquids may pass from the holding area 115 through the grated floor 112 to the tray 120, which may be removed (FIG. 3) and cleaned as necessary. By using the animal grooming apparatus 100, the animal may be groomed (e.g., dried, etc.) with minimal risk to the groomer, as only the groomer's hands and forearms may be exposed to the animal.

It is understood that while certain forms of this invention have been illustrated and described, it is not limited thereto except insofar as such limitations are included in the following claims and allowable functional equivalents thereof.

1. An animal grooming apparatus, comprising:
an enclosure defining a holding area and having a floor, a ceiling, and a plurality of walls;
a forced air dryer outside said holding area;
a hose coupled to said forced air dryer and extending inside said holding area for guiding air from said forced air dryer to said holding area;
a vacuum pump outside said holding area and having an intake and an exhaust; and
a duct extending from said holding area to adjacent said vacuum pump intake.

2. The apparatus as in claim 1, wherein at least one said wall defines at least one access hole sized to pass a human hand and forearm therethrough.

3. The apparatus as in claim 1, wherein at least one said wall includes at least one door.

4. The apparatus as in claim 1, wherein at least a portion of one said wall is transparent.

5. The apparatus as in claim 1, wherein:
one said wall includes first and second doors; and
each said door includes a respective access hole sized to pass a human hand and forearm therethrough.

6. The apparatus as in claim 5, wherein:
said ceiling is transparent; and
each said door is transparent.

7. The apparatus as in claim 1, further comprising a tray removably positioned below said floor, and wherein said floor is grated to allow fluid to pass from said holding area to said tray.

8. The apparatus as in claim 1, wherein said air from said forced air dryer is unheated.

9. The apparatus as in claim 1, further comprising a flexible arm positioned inside said holding area, said flexible arm being coupled to said hose for selectively maintaining said hose in a plurality of respective configurations.

10. The apparatus as in claim 9, further comprising:
a removable waste bag selectively coupled to said vacuum pump for containing items passed through said duct; and
a removable filter selectively coupled to said vacuum pump between said waste bag and said vacuum pump exhaust to keep said items passed through said duct in said waste bag.

11. The apparatus as in claim 10, further comprising a tray removably positioned below said floor, and wherein said floor is grated to allow fluid to pass from said holding area to said tray.

12. The apparatus as in claim 1, further comprising a removable waste bag selectively coupled to said vacuum pump for containing items passed through said duct.

13. An animal grooming apparatus, comprising:
an enclosure having a floor and a plurality of walls that collectively define a holding area;
a forced air dryer outside said holding area;
a hose coupled to said forced air dryer and extending inside said holding area for guiding unheated air from said forced air dryer to said holding area;
a vacuum pump outside said holding area, said vacuum pump having an intake and an exhaust; and
a duct extending from said holding area to adjacent said vacuum pump intake.

14. The apparatus as in claim 13, further comprising a plurality of legs coupled to said enclosure for maintaining said enclosure at a preselected height.

15. The apparatus as in claim 13, wherein a respective wall defines at least two access holes, each access hole being sized to pass a human hand and forearm therethrough.

16. The apparatus as in claim 15, wherein a respective wall includes at least one door.

17. The apparatus as in claim 13, further comprising a tray removably positioned below said floor, and wherein said floor is grated to allow fluid to pass from said holding area to said tray.

18. The apparatus as in claim 17, further comprising a flexible arm inside said holding area, said flexible arm being coupled to said hose for selectively maintaining said hose in a plurality of respective configurations.

19. The apparatus as in claim 18, further comprising:
a removable waste bag selectively coupled to said vacuum pump for containing items passed through said duct; and
a removable filter selectively coupled to said vacuum pump between said waste bag and said vacuum pump exhaust to keep said items passed through said duct in said waste bag.

20. The apparatus as in claim 13, further comprising a flexible arm inside said holding area, said flexible arm being coupled to said hose for selectively maintaining said hose in a plurality of respective configurations.
